(19) United States
(12) Patent Application Publication
(10) Pub. No.: US 2007/0171999 A1
(43) Pub. Date: Jul. 26, 2007

(54) Carrier phase ambiguity correction via dc offset

(76) Inventors: Gabriel Alfred Edde, Indianapolis, IN (US); Ivonete Markman, Carmel, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/579,970

(22) PCT Filed: Apr. 28, 2005
(86) PCT No.: PCT/US05/14428

§ 371 Date: Nov. 10, 2006

Related U.S. Application Data
(60) Provisional application No. 60/570,291, filed on May 12, 2004.

(51) Int. Cl. H04L 25/06

(52) U.S. Cl. 375/319

(57) ABSTRACT

A receiver comprises a carrier tracking loop (CTL), a filter, a look-up table and a rotator The CTL provides a base-band signal having in-phase and quadrature signal components. The filter provides a DC-offset level associated with each component to the look-up table, which, in response thereto, provides a phase adjustment signal to the rotator The latter then rotates the baseband signal as a function of the phase adjustment signal for correcting for carrier phase ambiguity.

### BACKGROUND OF THE INVENTION

The present invention generally relates to communications systems and, more particularly, to a receiver.

In modern digital communication systems like the ATSC-DTV (Advanced Television Systems Committee-Digital Television) system (e.g., see, United States Advanced Television Systems Committee, “ATSC Digital Television Standard”, Document A/53, Sep. 16, 1995 and “Guide to the Use of the ATSC Digital Television Standard”, Document A/54, Oct. 4, 1995), advanced modulation, channel coding and equalization are usually applied. In ATSC-DTV, the modulation system consists of suppressed carrier vestigial sideband (VSB) modulation with an added small in-phase pilot at the suppressed carrier frequency, 11.3 dB below the average signal power. Unfortunately, in processing the received ATSC-DTV signal, receiver demodulator techniques generally have intrinsic carrier phase and/or symbol timing ambiguities due to their phase and time detector design.

### SUMMARY OF THE INVENTION

In accordance with the principles of the invention, a receiver comprises a filter for providing at least one DC-offset level associated with a signal; and a phase corrector for correcting a phase of the signal as a function of the at least one DC-offset level.

In an embodiment of the invention, an ATSC receiver comprises a carrier tracking loop (CTL), a filter, a look-up table and a rotator. The CTL provides a baseband signal having in-phase and quadrature signal components. The filter provides a DC-offset level associated with each component to the look-up table, which, in response thereto, provides a phase adjustment signal to the rotator. The latter then rotates the baseband signal as a function of the phase adjustment signal for correcting for carrier phase ambiguity.

In another embodiment of the invention, an ATSC receiver comprises a carrier tracking loop (CTL), a filter and a phase corrector element. The CTL provides a baseband signal having in-phase and quadrature signal components. The filter provides a DC-offset level associated with each component to the phase corrector element. The latter has at least two modes of operation: a track mode and a hold mode. In the track mode, the phase corrector element tracks the phase ambiguity of the baseband signal and adjusts the phase of the baseband signal as a function of the DC-offset level associated with each component of the baseband signal. In the hold mode, the phase corrector element does not track the phase ambiguity of the baseband signal and applies a fixed phase adjustment to the baseband signal.

### BRIEF DESCRIPTION OF THE DRAWINGS

FIG. 1 shows a block diagram of a prior art ATSC receiver;

FIG. 2 shows an illustrative high-level block diagram of a receiver embodying the principles of the invention;

FIGS. 3 and 4 show illustrative portions of a receiver embodying the principles of the invention;

FIG. 5 shows Table One;

FIG. 6 shows Table Two; and

FIGS. 7 and 8 show illustrative flow charts in accordance with the principles of the invention.

### DETAILED DESCRIPTION

Other than the inventive concept, the elements shown in the figures are well known and will not be described in detail. Also, familiarity with television broadcasting and receivers is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Likewise, other than the inventive concept, transmission concepts such as eight-level vestigial sideband (8-VSB), Quadrature Amplitude Modulation (QAM), and receiver components such as a radio-frequency (RF) front-end, or receiver section, such as a low noise block, tuners, demodulators, correlators, leak integrators and squarers is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

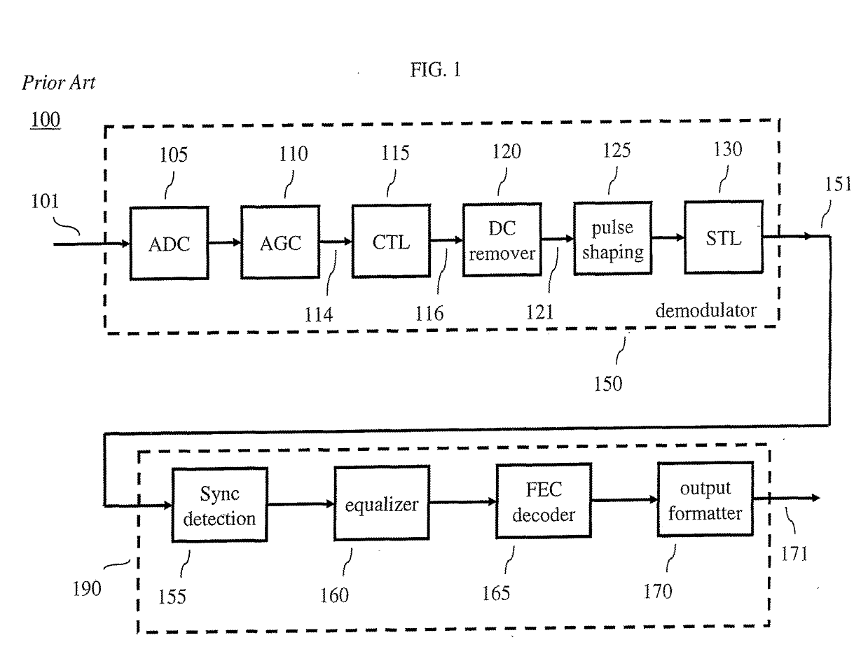

Before describing the inventive concept, a block diagram of a prior art receiver 100 is shown in FIG. 1 for use in an ATSC-DTV system. As known in the art, some of the signal paths described below are complex. Receiver 100 comprises a demodulator 150 and signal processing element 190. Input signal 101 represents a digital VSB modulated signal in accordance with the above-mentioned “ATSC Digital Television Standard” and is centered at a specific IF (Intermediate Frequency) of F_{IF} Hertz or near baseband. Demodulator 150 (described further below) demodulates input signal 101 and provides demodulated signal 151 to signal processing element 190. The latter processes demodulated signal 151 to provide output signal 171, which is representative of MPEG-2 serial or parallel data packets and control signals for the transport layer, as known in the art. As shown in FIG. 1, signal processing element 190 further comprises the following processing elements: sync detection element 155, equalizer 160, forward error correction (FEC) decoder 165 and output formatter 170. Sync detection element recovers the segment sync signal and field sync signal and delivers information to the subsequent receiver blocks. Equalizer 160 compensates for linear distortion introduced into the received signal by the communication channel or additional filtering. FEC decoder 165 performs the functions of trellis decoding, deinterleaving, Reed-Solomon (RS) decoding and derandomizing. Finally, output formatter 170 delivers MPEG-2 serial or parallel data packets and control signals for the transport layer, via signal 171, for use by other components (not shown) of receiver 100.

Turning back to demodulator 150, and as shown in FIG. 1, this element comprises analog-to-digital converter (ADC) 105, automatic gain control (AGC) 110, carrier tracking loop (CTL 115), DC remover 120, pulse shaping element 125 and symbol timing loop (STL) 130. Input signal 101 is sampled (e.g., at a sampling rate of 25.14 MHz) by ADC 105 for conversion to a sampled signal, which is then gain controlled by AGC 110. The latter adjusts the signal power to stable levels despite external imparments like signal fading and provides gain controlled signal 114 to CTL 115. CTL 115 works at the sampling rate and downconverts gain controlled signal 114 to baseband and also corrects for any frequency offsets between the transmitter carrier and the receiver tuner Local Oscillator (LO) (not shown) to provide baseband signal 116 (a complex signal). DC remover 120 then removes any DC offset from baseband signal 116 that might result from the VSB pilot carrier downconversion. DC remover 120 is typically a Low Pass Filter (LPF) of very low bandwidth of, for example, 1 KHz. DC remover 120 provides signal 121 to pulse shaping element 125, which is illustratively a root-raised cosine pulse shaping filter. The resulting pulse shaped signal is then provided to STL 130, which performs sample rate conversion to the average symbol rate of 10.76 MHz and provides demodulated signal 151.

As previously mentioned, receiver demodulator techniques generally have intrinsic carrier phase and/or symbol timing ambiguities due to their phase and time detector design. As a result, when the demodulator locks, the output sample it sends to subsequent blocks of the receiver may not have the correct and most appropriate value. This implies that subsequent blocks must correct for these possible ambiguities, be immune to these possible ambiguities or operate with substandard and possibly unacceptable performance. In fact, in order to achieve better and faster equalizer convergence, it is often desirable to correct for these demodulator ambiguities prior to equalization, particularly when the equalizer is a real (as opposed to complex), symbol-spaced (as opposed to fractionally-spaced) equalizer.

Therefore, and in accordance with the principles of the invention, a receiver comprises a filter for providing at least one DC-offset level associated with a signal; and a phase corrector for correcting a phase of the signal as a function of the at least one DC-offset level.

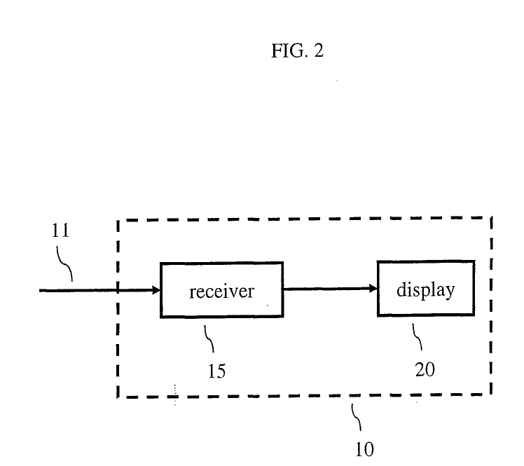

A high-level block diagram of an illustrative television set 10 in accordance with the principles of the invention is shown in FIG. 2. Television (TV) set 10 includes a receiver and a display 20. Illustratively, receiver 15 is an ATSC-compatible receiver. It should be noted that receiver 15 may also be NTSC (National Television Systems Committee)-compatible, i.e., have an NTSC mode of operation and an ATSC mode of operation such that TV set 10 is capable of displaying video content from an NTSC broadcast or an ATSC broadcast. For simplicity in describing the inventive concept, only the ATSC mode of operation is described herein. Receiver 15 receives a broadcast signal 11 (e.g., via an antenna (not shown)) for processing to recover therefrom, e.g., an HDTV (high definition TV) video signal for application to display 20 for viewing video content thereon.

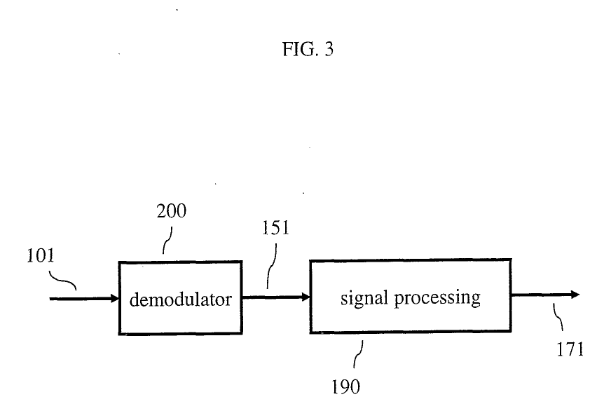

In accordance with the principles of the invention, receiver 15 includes a demodulator that corrects for carrier phase ambiguity. An illustrative block diagram of the relevant portion of receiver 15 is shown in FIG. 3. A demodulator 200 receives a signal 101 that is centered at an IF frequency (F_{IF}), or near baseband, and has a bandwidth equal to 6 MHz (millions of hertz). As described further below, demodulator 200 corrects for carrier phase ambiguity and provides a demodulated received ATSC-DTV signal 151 to signal processing element 190. The latter, as described above, processes demodulated signal 151 to provide output signal 171, which is representative of MPEG-2 serial or parallel data packets and control signals for the transport layer, as known in the art. In this illustrative embodiment, it is assumed that demodulator 200 corrects for a carrier phase ambiguity of 0°, 90°, 180° or 270°.

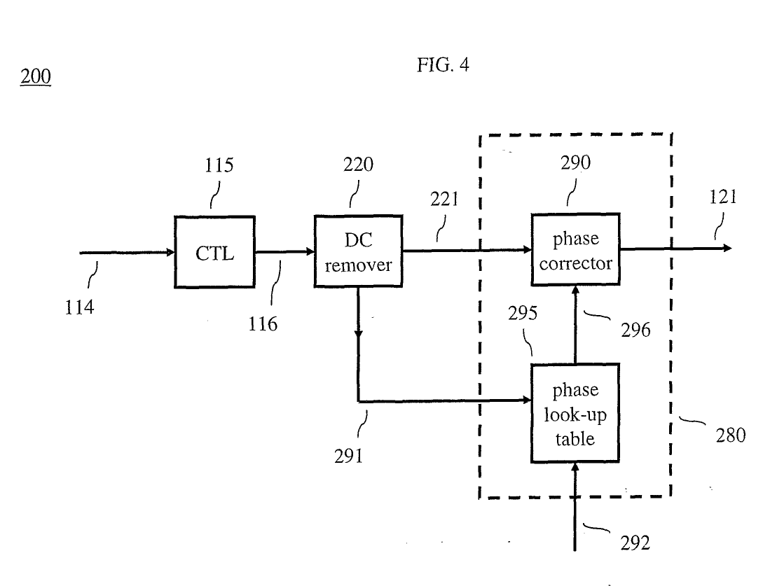

Referring now to FIG. 4, an illustrative block diagram of the relevant portion of demodulator 200 is shown. Demodulator 200 comprises CTL 115, DC remover 220 (also referred to herein as filter 220) and phase correction element 280. The latter comprises phase corrector 290 (also referred to herein as rotator 290) and phase look-up table 295. Other components of demodulator 200 not shown in FIG. 4 are similar to those described above and shown in FIG. 1.

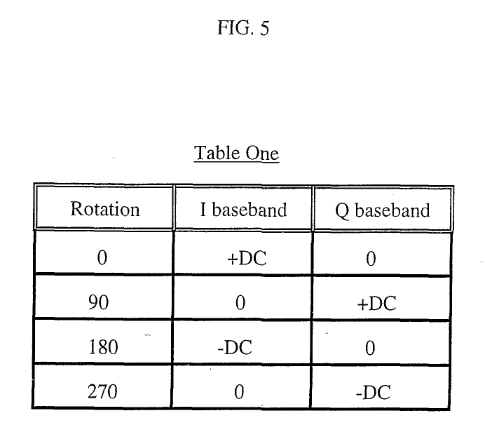

In accordance with the principles of the invention, demodulator 200 corrects for carrier phase ambiguity by using information from the VSB pilot carrier signal. In particular, the VSB specification (e.g., see the above-noted ATSC Document A/53) Sep. 16, 1995) describes the pilot signal as a small carrier that is added to the VSB signal that is in phase with a zero degree (0°) phase reference. The purpose of the pilot signal is to be used as a lock reference for the demodulator. After CTL 115 is locked, the pilot signal shows as a constant “DC level” in baseband signal 116 and is subtracted out by DC remover 220. However, we have observed that in the case of a demodulator that provides both in-phase (I) and quadrature (Q) components in baseband signal 116 and because the pilot carrier signal shows as a DC level in the baseband output of the demodulator when locked, it is possible to determine the carrier phase rotation by observing the DC level polarity (+/−) and the particular component (I/Q) that contains the constant DC level signal. This is illustrated in Table One of FIG. 5, which illustrates for a particular degree of rotation the associated I and Q values. For example, if baseband signal 116 is rotated by 90°, the Q component of baseband signal 116 contains a positive (+) DC level, while if baseband signal 116 is rotated by 180°, the I component of baseband signal 116 contains a negative (−) DC level.

With respect to Table One, this table is derived by using the following equations:
Ibaseband=DC*(cos(Rotation)+j*sin(Rotation)), and (1)
Qbaseband=DC*(sin(Rotation)+j*cos(Rotation)), (2)
where DC is equal to a constant value that is proportional to the level of the pilot signal and Rotation is equal to the stationary rotation value of the demodulator under a lock condition.

If the originally transmitted zero phase input baseband signal is:
Vs=Iin+j*Qin, (3)
then when the received signal is ambiguously rotated, the following results:
Vrotated=Vs*exp(j*Rotation), (4)
where Vrotated is baseband signal 116 of FIG. 4. As such, the received uncorrected signal is:
Vrotated=Iin′+j*Qin′. (5)

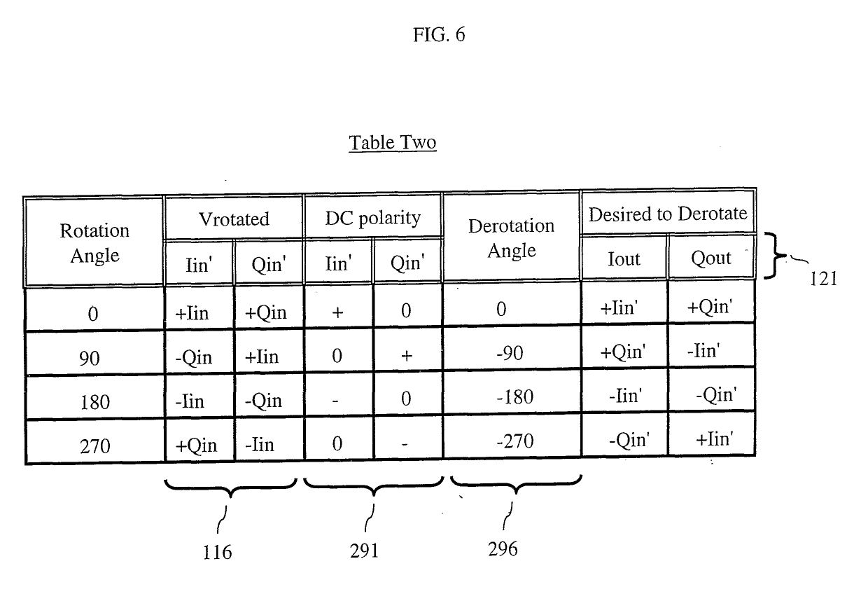

Turning now to Table Two of FIG. 6, this table further illustrate the operation of the elements shown in FIG. 4. As noted above from equation (5), baseband signal 116 has I and Q components designated as Iin′ and Qin′, respectively. DC remover 220 is a low pass filter that removes the DC-offset caused by the VSB pilot from baseband signal 116 and provides signal 221 to phase corrector 290 (this portion of DC remover 220 functions in a fashion similar to that of DC remover 120 of FIG. 1). In addition, DC remover 220 also provides a measurement of the DC polarity present on the I and Q components of baseband signal 16 to phase look-up table 295, via signal 291. Phase corrector 290 adjusts the phase of signal 221 (and therefore baseband signal 116) under the control of signal 296, which is determined by phase look-up table 295 in accordance with Table Two of FIG. 6. For example, if baseband signal 116 is rotated by 90°, the Q component of baseband signal 116 (Qin′) contains a positive (+) DC level. In order to remove this ambiguity, phase look-up table 295 controls, via signal 296, phase corrector 290 of FIG. 4 to rotate signal 221 by a negative (−) 90°. As can be observed from Table Two of FIG. 6, this can be accomplished by phase corrector 290 setting the in-phase component, lout, of signal 121 to the quadrature component, Qin′, of signal 221 and setting the quadrature component, Qout, of signal 121 to the negative of the in-phase component, p31 Iin′, of signal 221. (In this context, references herein to the in-phase and quadrature components of baseband signal 116 and signal 221 are interchangeable.) As another example, assume that the phase ambiguity of baseband signal 116 is 270°. In this case, there would be a negative DC offset in the quadrature component, Qin′, of signal 116. To correct (derotate) for this rotation, phase look-up table 295 controls, via signal 296, phase corrector 290 of FIG. 4 to rotate signal 221 by a negative (−) 270°. As can be observed from Table Two of FIG. 6, this can be accomplished by phase corrector 290 setting the in-phase component, Iout, of signal 121 to the negative of the quadrature component, Qin′, of signal 221, and setting the quadrature component, Qout, of signal 221 to the in-phase component, Iin′, of signal 221.

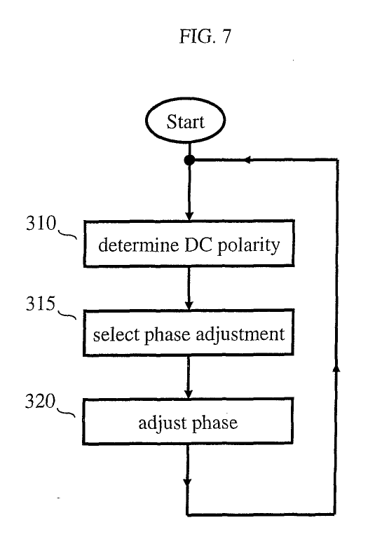

Turning briefly to FIG. 7, an illustrative flow chart in accordance with the principles of the invention for use in receiver 15 is shown. In step 310, the DC polarity for each component of a complex signal is determined. In step 315, a phase adjustment is selected as a function of the determined DC polarity. And, in step 320, the phase of the complex signal is adjusted in accordance with the selected phase adjustment.

Although the general operation of phase correction element 280 in accordance with the principles of the invention is as described above, it should be observed from FIG. 4 that phase correction element 280 has a control signal 292. Control signal 292 controls the mode of operation of phase correction element 280 and is provided by a processor (not shown) of receiver 15. In this example, phase correction element 280 has two modes of operation, a track mode and a hold mode. However, the inventive concept is not so limited. In the track mode, phase correction element 280 functions as described above and phase look-up table 295 determines the proper phase shift required to derotate baseband signal 116 and provides this determined phase shift to phase corrector 290 via signal 296. However, in the hold mode, phase correction element 280 does not track baseband signal 116 but, instead, holds the present phase adjustment. In particular, phase look-up table 295 holds the value present on signal 296 irrespective of the DC offset present in baseband signal 116. In other words, phase correction element 280 only tracks baseband signal 116 while in track mode. Illustratively, phase correction element 280 is in track mode when demodulator 200 is in acquisition mode. Once demodulator 200 has acquired and locked to input signal 101, phase correction element 280 is set to hold mode (e.g., by the above-noted processor (not shown)). This is to provide a stable output signal to the remaining blocks (not shown in FIG. 4) in receiver 15. It is presumed that once the demodulator 200 is locked to input signal 101, further processing (such as by equalizer 160 of signal processing element 190 (shown in FIG. 1)) will track any further changes in input signal 101. Thus, after demodulator 200 has acquired input signal 101, demodulator 200 remains stable in the hold mode until the receiver 15 loses lock and needs to reacquire.

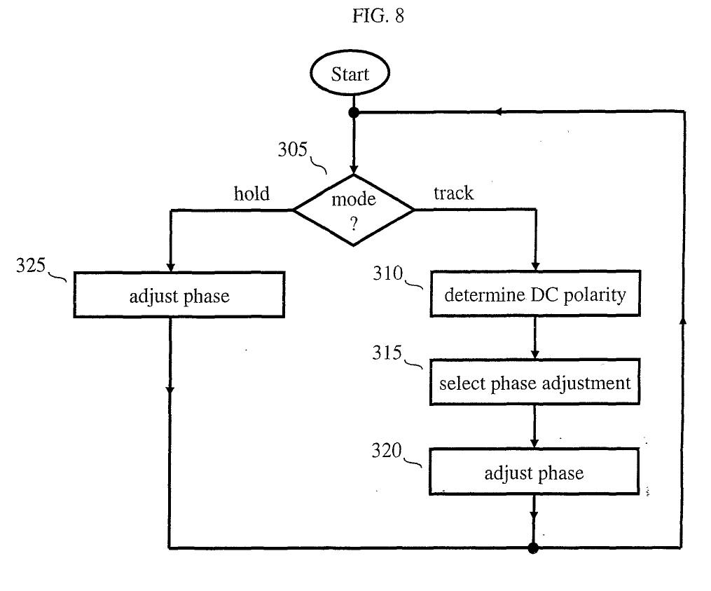

Referring now to FIG. 8, another illustrative flow chart in accordance with the principles of the invention for use in receiver 15 is shown in the context of the above-described track and hold modes of operation. The flow chart of FIG. 8 is similar to the flow chart of FIG. 7 except for the additions of step 305 and 325. In step 305, the mode of operation is determined. If the mode of operation is the track mode, then steps 310, 315 and 320 are performed as described earlier. However, if the mode of operation is the hold mode, then the phase of the complex signal is adjusted in step 325 in accordance with the last selected phase adjustment and is independent of the current DC polarity of the complex signal.

It should be noted that the in-phase and quadrature value for DC polarity shown in Tables One and Two represent ideal conditions of a perfect input signal. In reality, it is possible for either or both of these values to be non-zero due to noise and other non-ideal conditions. In other words, in the DC Polarity entries of Table Two a value of zero (0) actually can have a low DC value due to noise, etc. As such, in order to handle this possibility, phase correction element 280 uses the magnitudes of the DC polarity values and compares them to see which signal is the furthest from a value of zero. Once this is determined, phase correction element 280 checks the component of baseband signal 116 that has the value furthest from zero to see if it is positive or negative and, thus, determine which entry to use in Table Two. In other words, the lower of the two values is treated as zero and the higher of the two values is treated as “DC”.

Although the inventive concept was described in terms of a VSB demodulator, the inventive concept may be applied to any digital demodulator with carrier phase ambiguities for which one or more pilot carriers or full carriers are present at the transmitted signal. Likewise the inventive concept is applicable not only to digital systems but analog as well. In addition, other variations are possible. For example, detector 280 may be located at other positions within the receiver, such as after STL 130 of FIG. 1, etc.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements of may be implemented in a stored-program-controlled processor, e.g., a digital signal processor, which executes associated software, e.g., corresponding to one or more of the steps shown, e.g., in FIG. 7, etc. Further, although shown as elements bundled within TV set 10, the elements therein may be distributed in different units in any combination thereof. For example, receiver 15 of FIG. 2 may be a part of a device, or box, such as a set-top box that is physically separate from the device, or box, incorporating display 20, etc. Also, it should be noted that although described in the context of terrestrial broadcast, the principles of the invention are applicable to other types of communications systems, e.g., satellite, cable, etc. It is therefore to be understood that numerous modifications may be made to the illustrative embodiments and that other arrangements may be devised without departing from the spirit and scope of the present invention as defined by the appended claims.

1. A receiver, comprising:
a downconverter for downconverting a received signal that includes a pilot signal to provide a downconverted signal having a DC-offset level resulting from the downconversion of the received pilot signal;
a filter for removing the DC-offset level from the downcoverted signal to provide a filtered signal; and
a phase corrector for correcting a phase of the filtered signal as a function of the DC-offset level of the downconverted signal.

2. The receiver of claim 1, wherein the phase corrector comprises:
a look-up table for providing a carrier phase correction value from the DC-offset level; and
a rotator for rotating the filtered signal by the carrier phase correction value to correct the phase.

3. The receiver of claim 1, wherein the received signal represents an ATSC-DTV (Advanced Television Systems Committee-Digital Television) signal.

4. The receiver of claim 1, wherein the received signal is a complex signal having an in-phase component and a quadrature component and the downconverter provides a DC-offset level for each component.

5. The receiver of claim 1, wherein the DC-offset level represents a phase ambiguity associated with the received signal; and wherein the phase corrector has a hold mode of operation such that in the hold mode of operation the phase corrector does not track the phase ambiguity of the received signal.

6. A method for use in a receiver, comprising:
(a) downconverting a received signal that includes a pilot signal to provide a downconverted signal having a DC-offset level resulting from the downconversion of the received pilot signal;
(b) filtering the downconverted signal for removing the DC-offset level to provide a filtered signal; and
(c) correcting a phase of the filtered signal as a function of the DC-offset level of the downconverted signal.

7. The method of claim 6, wherein the correcting step includes:
addressing a look-up table with the DC-offset level for providing a carrier phase correction value; and
rotating the filtered signal by the carrier phase correction value to correct the phase.

8. The method of claim 6, wherein the received signal represents an ATSC-DTV (Advanced Television Systems Committee-Digital Television) signal.

9. The method of claim 6, wherein the received signal is a complex signal having an in-phase component and a quadrature component and the downconverting step provides a DC-offset level for each component.

10. The method of claim 6, wherein the DC-offset level represents a phase ambiguity associated with the received signal; and further comprising the step of:
selecting one of a number of modes of operation,
wherein at least one mode of operation is a track mode such that when the track mode is selected step (c) tracks the phase ambiguity of the received signal, and
wherein another mode is a hold mode such that such that when the hold mode is selected step (c) does not track the phase ambiguity of the received signal.
